(19) United States
(12) Patent Application Publication
(10) Pub. No.: US 2013/0276793 A1
(43) Pub. Date: Oct. 24, 2013

(54) Stereotactic Halo Pillow

(71) Applicant: William E. Patton, Rochester, NY (US)

(72) Inventor: William E. Patton, Rochester, NY (US)

(21) Appl. No.: 13/850,894

(22) Filed: Mar. 26, 2013

Related U.S. Application Data
(60) Provisional application No. 61/615,606, filed on Mar. 26, 2012.

(51) Int. Cl. A61G 13/12

(52) U.S. Cl. CPC A61G 13/1295; A61G 13/121; A61G 13/1225
USPC 128/845

(57) ABSTRACT

A device comprising: a backboard; a resilient material that is coupled to the backboard, wherein the resilient material comprises a tapered shape; wherein the resilient material comprises a groove, a first section and a second section; wherein the groove is between the first section and the second section; wherein the groove is configured to receive a stereotactic halo; wherein the first and second portions are configured to provide uniform anatomical support upon insertion of the stereotactic halo into the groove.

### CLAIM OF PRIORITY

This application claims priority under 35 U.S.C. §119(e) to U.S. Provisional Patent Application No. 61/615,606, filed Mar. 26, 2012, the entire contents of which are hereby incorporated by reference.

### BACKGROUND

A stereotactic halo includes a one inch thick ring which projects out approximately 2½ inches all around the head just above eye level used for various medical procedures. The halo is attached to the head using four (4) bolts which are screwed into the skull bone, where it remains throughout the medical procedure. It's restrictive design makes it extremely uncomfortable to wear, regardless of the specific medical necessity requiring its application.

### DESCRIPTION OF DRAWINGS

Appendix A, the entire contents of which are incorporated herein by reference.

FIGS. 1-4 are images of the stereotactic halo pillow with a covering.

FIGS. 5-6 are images of material on the inside of the stereotactic halo pillow.

FIGS. 7-8 are schematic diagrams of the stereotactic halo pillow.

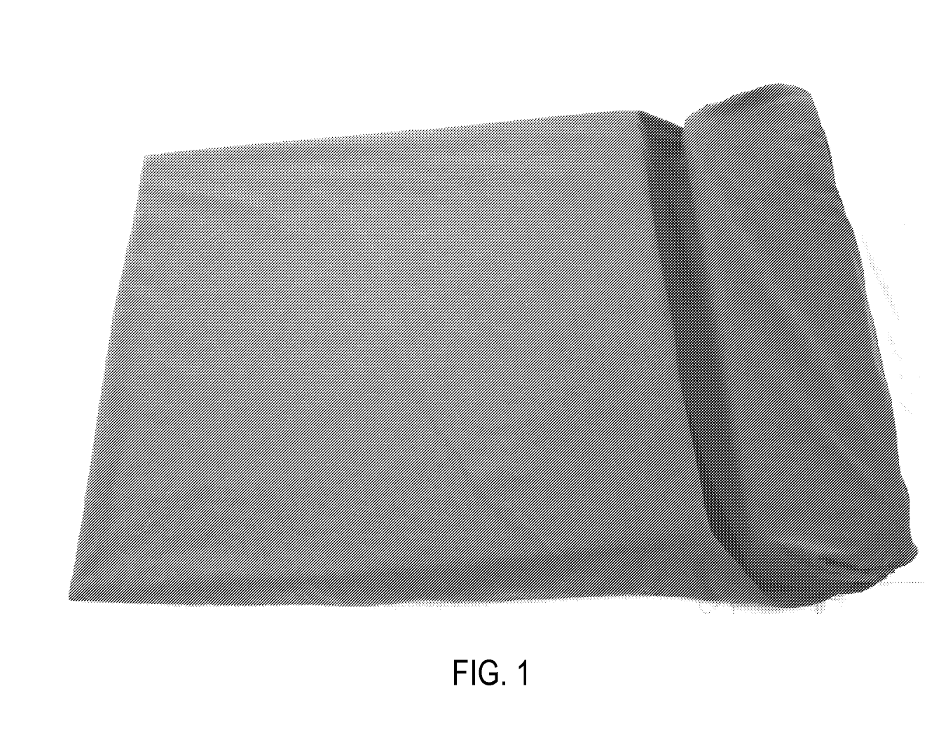

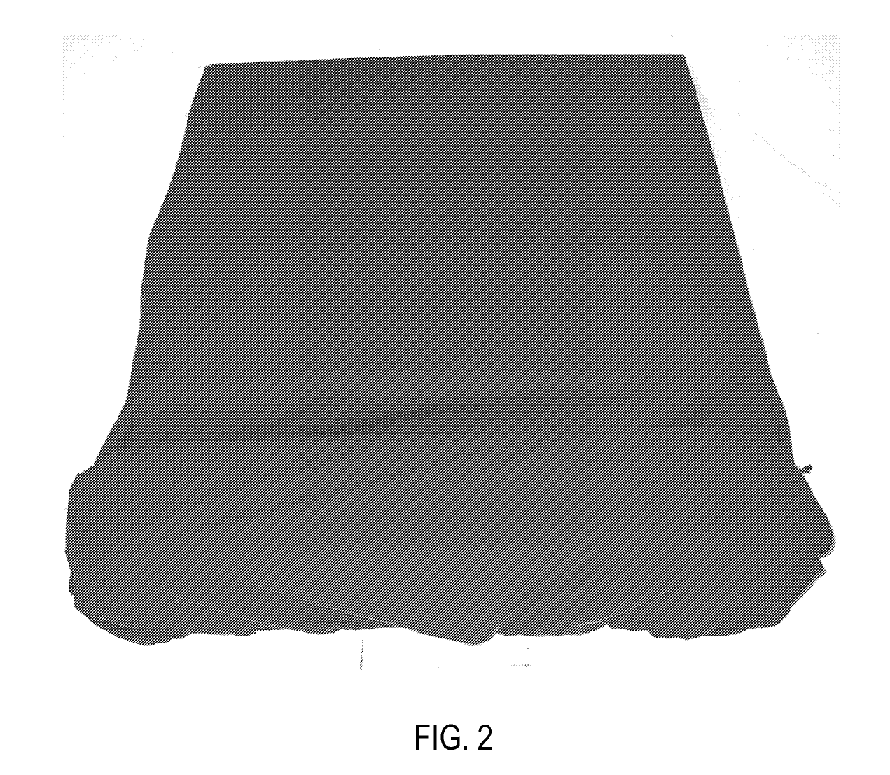

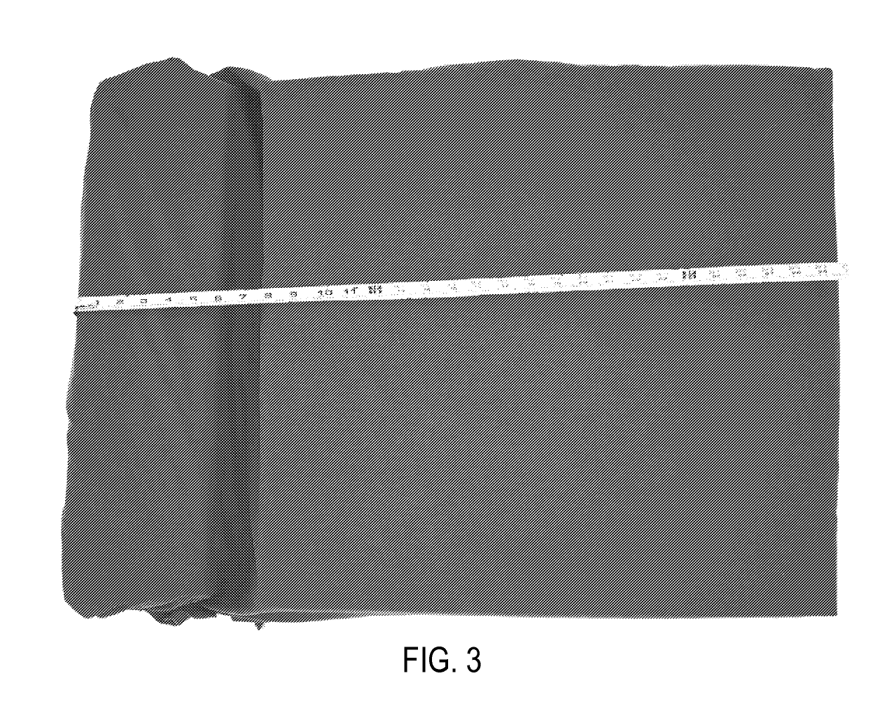

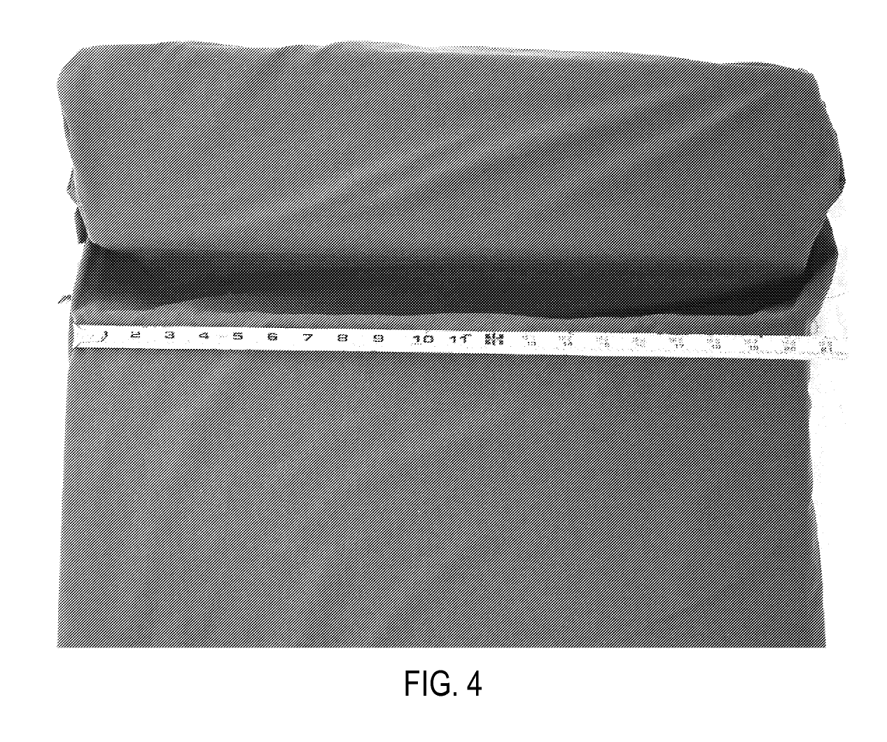

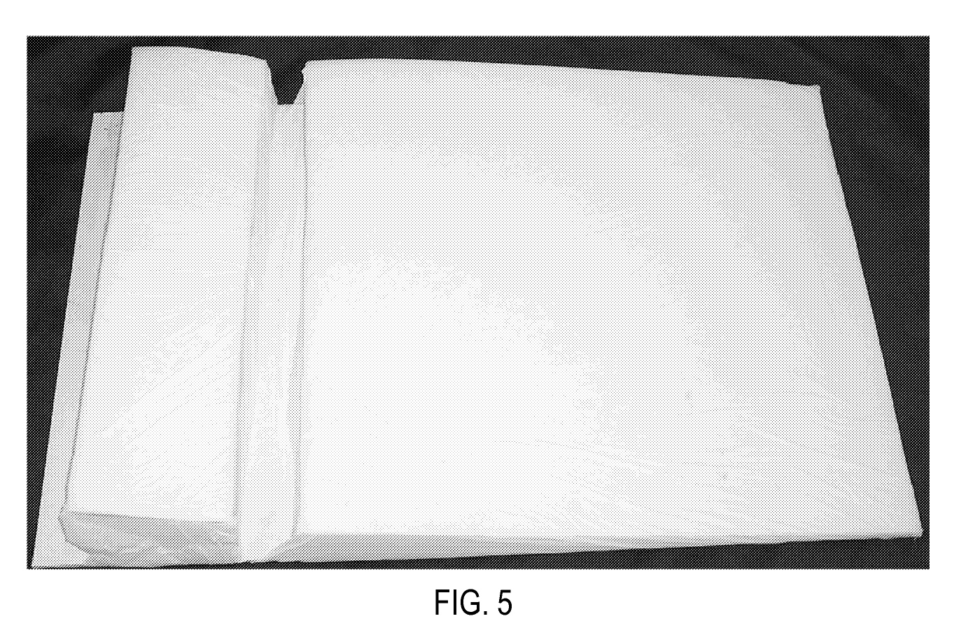

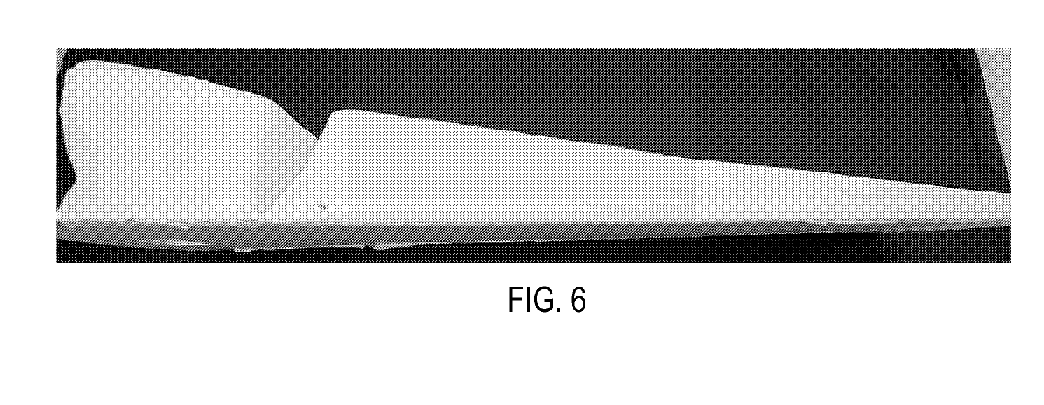

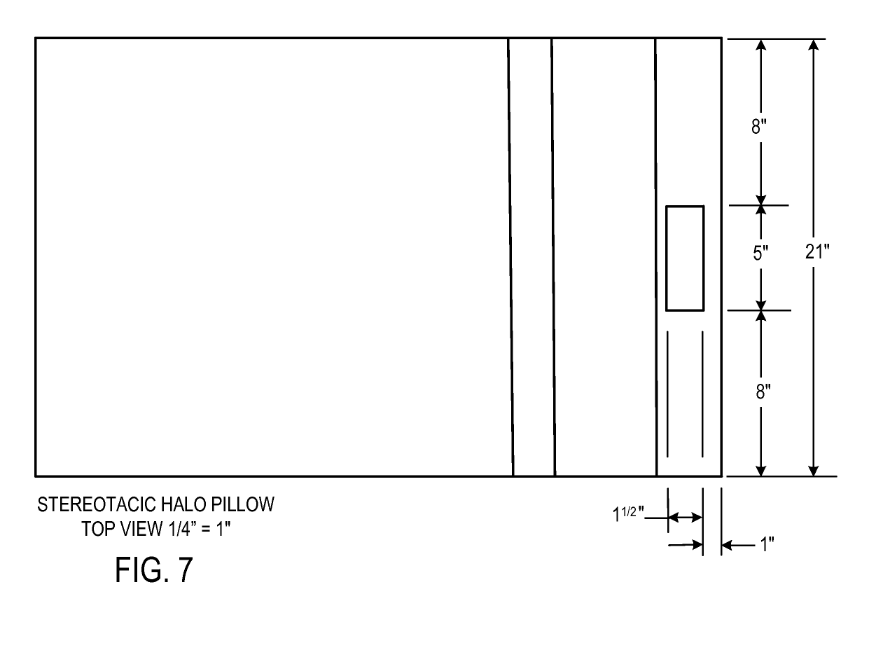

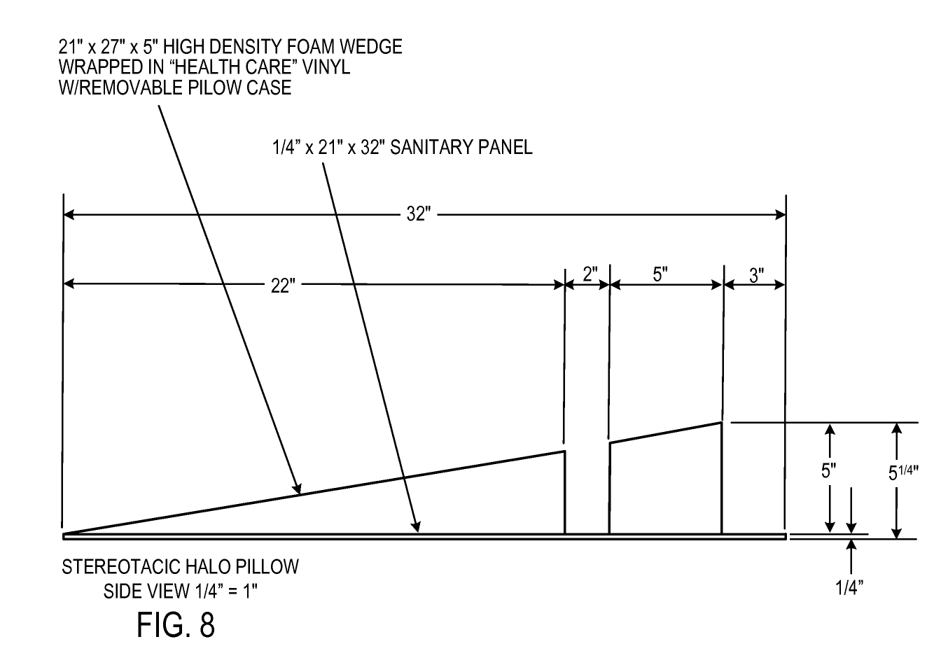

### DETAILED DESCRIPTION

Described herein is a device/pillow (stereotactic halo pillow—SHP) designed for use while using a stereotactic halo. The SHP includes a flexible backboard with a high-density foam wedge permanently attached. Through the flexible backboard, the two sections of foam are held together. The backboard is flexible to promote use of the backboard in various sizes of hospital beds, hospitals chairs and to promote ease in placing the SHP under a patient. A two (2) inch groove is cut horizontally side to side in the foam wedge. The halo fits into the groove and the foam provides support for your neck and your whole head, e.g., to decrease the amount of strain on your neck muscles and upper shoulders that are caused by the halo.

In an example, the SHP is placed against a chair and/or a portion of a bed. The halo is then positioned into the groove to facilitate comfort for an individual attempting to relax.

In still another example, a portion of the foam section (e.g., the longer portion of the foam section) is twenty-inches long. In this example, the length from the top of the ears to the lower back, of an average proportioned individual, is twenty-two inches. In this example, the longer portion of the foam section is twenty-two inches in length, e.g., to support an individual from the top of the ears to the lower back.

In another example, the foam is a wedge shape. Through the wedge shape, the SHP may fit under your back, e.g., to promote uniform support and to emulate lying down on a bed. In contrast to a square or a rectangular shape that does not provide uniform support, the wedge shape provides uniform support to your back. Through the groove and the wedge shape of the SHP, no pressure and/or weight is placed on the halo itself. Rather, the SHP evenly supports your body weight from your back to the top of your head, without placing additional weight on the halo.

A plastic sheathing is then used to cover all areas of the remaining foam, leaving the backboard exposed. In an example, the plastic sheathing promotes cleaning of the SHP and is non-permeable, e.g., to prevent bacteria and viruses to enter into the foam. By the backboard being exposed, the backboard may be placed against surfaces, e.g., a bed surface and/or a chair.

In some example, the SHP includes a cloth pillow case and a neck support “bean bag.” There are many advantaged to the SHP, including, e.g., decrease in pain & discomfort for a patient, ability (of a patient) to rest while wearing a halo, and so forth. There are also numerous advantages to care providers, including, e.g., patient less restless—apparatus less likely to be disturbed, patient pain management improved (less medication, etc.), patient recovery time improved, patient experience less secondary complications and/or secondary care.

A number of embodiments have been described. Nevertheless, it will be understood that various modifications can be made without departing from the spirit and scope of the processes and techniques described herein. Accordingly, other embodiments are within the scope of the following claims.

What is claimed is:

1. A device comprising:
a backboard;
a resilient material that is coupled to the backboard, wherein the resilient material comprises a tapered shape;
wherein the resilient material comprises a groove, a first section and a second section;
wherein the groove is between the first section and the second section;
wherein the groove is configured to receive a stereotactic halo;
wherein the first and second portions are configured to provide uniform anatomical support upon insertion of the stereotactic halo into the groove.

2. The device of claim 1, wherein the resilient material comprises foam.

3. The device of claim 1, wherein the tapered shape comprises a wedge shape.

4. The device of claim 1, wherein the device comprises a pillow.

5. The device of claim 1, wherein insertion of the halo into the groove applies a decreased amount of pressure to the halo.
